(19) United States
(12) Patent Application Publication
(10) Pub. No.: US 2007/0038769 A1
(43) Pub. Date: Feb. 15, 2007

(54) Method and/or system of scheduling transmission of a power signal

(76) Inventors: Todd Curtis Ryan, Anaheim, CA (US); Ah Jee Wang, Irvine, CA (US)

Correspondence Address: BERKELEY LAW & TECHNOLOGY GROUP, 1700NW 167TH PLACE, SUITE 240, BEAVERTON, OR, 97006, US

(21) Appl. No.: 11/203,605

(22) Filed: Aug. 12, 2005

(51) Int. Cl. G06F 15/16

(52) U.S. Cl. 709/230

(57) ABSTRACT

Described are a system and method for scheduling transmission of a power signal. A predetermined schedule may determine when selected data ports transmit a power signal to devices connected to the data ports.

### BACKGROUND

1. Field:

The subject matter disclosed herein relates to systems and/or methods of connecting devices to a data transmission network.

2. Information:

For decades, cables have been used to connect devices to data transmission networks for the transmission of data according to any one of several data transmission protocols. In particular, devices are typically connected to a data transmission network employing techniques compliant with versions of the Ethernet standard under IEEE Std. 802.3 using media such as, for example, coaxial, unshielded twisted wire pair and optical cabling. In addition to setting forth techniques for the transmission of data between devices, the Ethernet standard in IEEE Std. 802.3 af-2003 has set forth techniques for transmitting a power signal to powered devices over cables that may also be used to transmit data.

### BRIEF DESCRIPTION OF THE FIGURES

Non-limiting and non-exhaustive embodiments will be described with reference to the following figures, wherein like reference numerals refer to like parts throughout the various figures unless otherwise specified.

FIG. 1 is a schematic diagram of an apparatus capable of applying a power signal to one or more data ports according to an embodiment.

FIG. 2 is a schematic diagram of an apparatus capable of applying a power signal to one or more data ports according to an alternative embodiment.

FIG. 3 is a schematic diagram of a computing platform to control scheduling transmission of a power signal to one or more data ports according to an embodiment.

### DETAILED DESCRIPTION

Reference throughout this specification to “one embodiment” or “an embodiment” means that a particular feature, structure, or characteristic described in connection with the embodiment is included in at least one embodiment of claimed subject matter. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Instructions” as referred to herein relate to expressions which represent one or more logical operations. For example, instructions may be “machine-readable” by being interpretable by a machine for executing one or more operations on one or more data objects. However, this is merely an example of instructions and claimed subject matter is not limited in this respect. In another example, instructions as referred to herein may relate to encoded commands which are executable by a processing circuit having a command set which includes the encoded commands. Such an instruction may be encoded in the form of a machine language understood by the processing circuit. Again, these are merely examples of an instruction and claimed subject matter is not limited in this respect.

“Storage medium” as referred to herein relates to media capable of maintaining expressions which are perceivable by one or more machines. For example, a storage medium may comprise one or more storage devices for storing machine-readable instructions and/or information. Such storage devices may comprise any one of several media types including, for example, magnetic, optical or semiconductor storage media. However, these are merely examples of a storage medium and claimed subject matter is not limited in these respects.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a storage medium in combination with processing circuitry to execute such machine-readable instructions. However, these are merely examples of structures which may provide logic and claimed subject matter is not limited in this respect.

Unless specifically stated otherwise, as apparent from the following discussion, it is appreciated that throughout this specification discussions utilizing terms such as “processing,” “computing,” “calculating,” “selecting,” “forming,” “enabling,” “inhibiting,” “identifying,” “initiating,” “querying,” “obtaining,” “hosting,” “maintaining,” “representing,” “modifying,” “receiving,” “transmitting,” “determining” and/or the like refer to the actions and/or processes that may be performed by a computing platform, such as a computer or a similar electronic computing device, that manipulates and/or transforms data represented as physical electronic and/or magnetic quantities and/or other physical quantities within the computing platform's processors, memories, registers, and/or other information storage, transmission, reception and/or display devices.

A “data transmission medium” as referred to herein relates to a medium that is capable of transmitting data between nodes in a communication network. Such a data transmission medium may comprise, for example, cabling (e.g., coaxial, optical, unshielded twisted wire pair and/or the like) or an air interface. However, these are merely examples of a data transmission medium and claimed subject matter is not limited in these respects.

A “power signal” as referred to herein relates to an electrical signal transmitted to a device for the purpose of enabling operation of at least one aspect and/or feature of the device. In one particular embodiment, a power signal may be provided at a controlled and/or predetermined, voltage, current and/or power level. Such a power signal may be transmitted over on or a plurality of conductors. However, these are merely examples of a power signal and claimed subject matter is not limited in these respects.

A “data port” as referred to herein comprises an interface of a device that is capable of transmitting data to and/or receiving data from a data transmission medium according to a data transmission format. In one particular embodiment, although claimed subject matter is not limited in this respect, a data port may comprise a physical interface that connects a device to a data transmission medium. Here, for example, a data port may be adapted to connect to a data transmission medium such as cabling (e.g., coaxial cabling, twisted wire pair cabling, optical cabling and/or the like) using connectors. In other embodiments, a data port may be capable of transmitting data to and from a device wirelessly over an air interface. However, these are merely examples of a data port and claimed subject matter is not limited in these respects.

According to an embodiment, a cable connected to a device may transmit a power signal to the device, in addition in addition to transmitting data to and/or receiving data from the device. Accordingly, a data port connected to a device by a cable may transmit power to the device through the cable, in addition to transmitting data to and/or receiving data from the connected device. Such a data port may be referred to as a “powered” data port as distinguished from an “unpowered” data port which is capable of transmitting data to and/or receiving data from a device, but not capable of transmitting a power signal to the device. Also, device connected to a data port that is capable of being powered, at least in part, from a power signal received from the connected data port may be referred to a as a “powered” device as distinguished from an “unpowered” device which is not capable of being powered by a power signal received from a connected data port. It should be understood, however, that such an unpowered device in this context may nevertheless receive power from sources other than a cable for transmitting data (e.g., battery power and/or other direct current power supply) to enable operation of the unpowered device.

A data port may, according to a particular embodiment, be adapted to operate in any one of a plurality of operational modes. Such operational modes may be controlled based, at least in part, on control signals. According to an embodiment, operation of one or more data ports may be controlled according to a predetermined schedule specifying how such data ports are to behave based, at least in part, on a time reference. In one particular example, such a predetermined schedule may define specific time intervals (e.g., times of day, days of the week and/or calendar days) during which a data port is to behave in a particular manner. In another embodiment, such a predetermined schedule may set forth particular time referenced conditions and/or events indicating when a data port is to behave in a particular manner. However, these are merely examples of a how a predetermined schedule may indicate how a data port may is to behave, and claimed subject matter is not limited in these respects.

Briefly, one embodiment relates to a system and/or method for scheduling transmission of a power signal from one or more data ports capable of transmitting data. Here, a predetermined schedule may determine when selected data ports transmit a power signal to devices connected to the data ports. However, this is merely a sample embodiment and claimed subject matter is not limited in these respects.

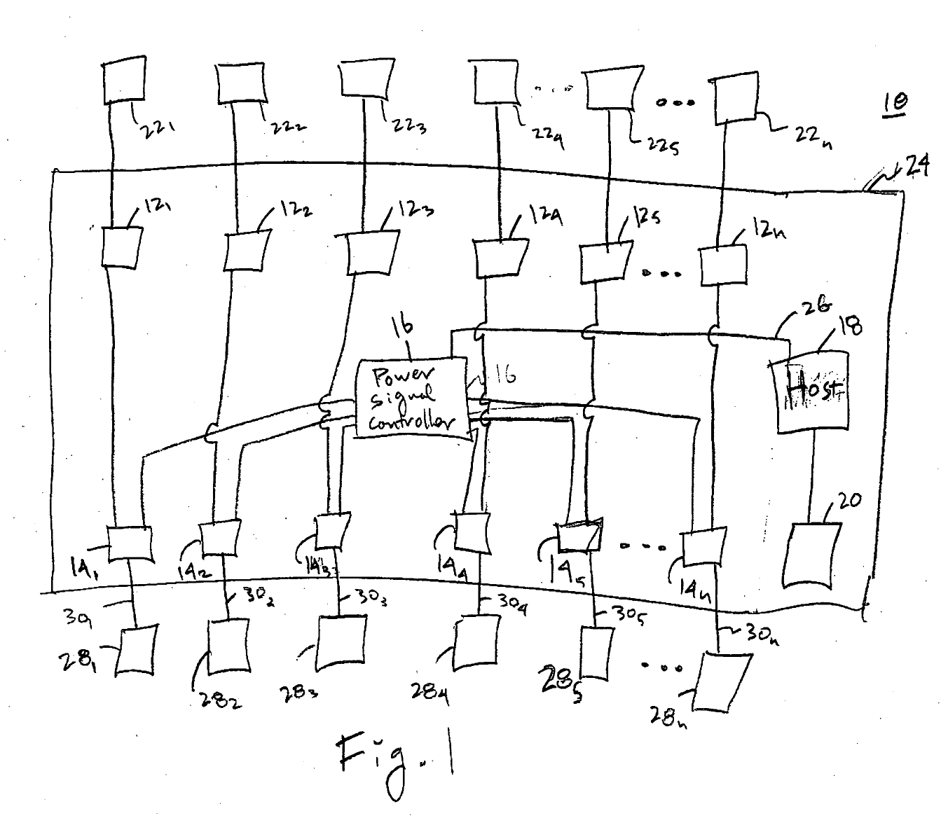

FIG. 1 is a schematic diagram of an apparatus 24 capable of applying a power signal to one or more data ports 14 according to an embodiment. Data ports 14 may be capable of transmitting data to and/or receiving data from corresponding devices 28 connected to data ports 14 by cables 30. Here, according to a particular embodiment, cables 30 are capable of transmitting data between devices 14 and 28, and capable of transmitting a power signal to devices 28 for enabling operation of at least one aspect of devices 28. Devices 28 may comprise any one of several devices that may communicate with a data transmission network through a data port and capable of being powered by a power signal received from a cable 30 such as, for example, a wireless local area network (WLAN) access point, data storage appliance, telephony device, network camera and/or the like. However, these are merely examples of devices that may comprise powered devices, and claimed subject matter is not limited in these respects.

A plurality of data ports 12 may be capable of transmitting data to and/or receiving data from corresponding devices 22 over a data transmission medium including, for example, cabling and/or a wireless transmission medium according to any one of several data transmission protocols such as, for example, versions of IEEE Std. 802.11, IEE Std. 802.3, IEEE 802.16, Universal Serial Bus (USB), Bluetooth, Firewire and/or the like. In the presently illustrated embodiment, although claimed subject matter is not limited in this respect, data ports 14 are connected to respective data ports 12 to transmit data between corresponding data ports 12 and corresponding devices 28. Accordingly, ports 14 are capable of transmitting data traffic between corresponding data ports 12 and devices 28, and transmitting a power signal to corresponding devices over cables 30.

According to a particular embodiment, although claimed subject matter is not limited in this respect, data may be transmitted between data ports and devices 28 using any one of several wired data transmission protocols such as, for example, versions of IEEE Std. 802.3, Firewire, Infiniband, USB and/or the like. In a particular embodiment, cables 30 may comprise twisted wire pair cabling such as, for example, category 5 and above cabling which are connectable to ports 14 by RJ-45 connectors. Such a cable 30 may comprise four wire pairs. Here, for example, two of the four wire pairs may be used to transmit data between the data port 14 and the device 28 according to a 10BASE-TX and/or 100BASE-TX protocol, for example. A third and/or fourth wire pair may then be used to transmit a power signal from the data port 14 to the device 28 according to IEEE Std. 802.3af-2003. However, these are merely examples of how a cable may be used to transmit data and a power signal between devices, and claimed subject matter is not limited in these respects.

According to an embodiment, although claimed subject matter is not limited in this respect, a power signal controller 16 may selectively transmit a power signal to data ports 14 in response to control signals from a host 18. In one particular example, power signal controller may comprise any one of several devices capable of selectively transmitting a power signal to data ports such as, for example, a Power Over Ethernet Manager device PD64012 sold by PowerDsine Ltd. However, this is merely an example of a power signal controller that is capable of selectively transmitting a power signal to data ports and claimed subject matter is not limited in these respects. Power signal controller 16 may receive control signals from host 18 on bus 26 according to any one of several control signal formats such as, for example, an I²C compatible bus signaling format. Here, control signals on bus 26 may be used to selectively enable and/or disable transmission of a power signal from power signal controller 16 to individual devices 28 through corresponding data ports 14. In particular embodiments, host 18 may dynamically determine which devices 28 are to receive a power signal from power signal controller 16 and which devices 28 are not to receive a power signal using control signals on bus 26 based, at least in part, on detecting conditions and/or events.

According to an embodiment, data ports 14 and/or power signal controller 16 may comprise logic to determine whether a device 28 connected by a cable 30 comprises a powered device. In response to determining that such a device 28 is not a powered device, a corresponding data port 14 connected to the device 28 and/or power signal controller 16 may inhibit transmission of a power signal to the device 28 through the data port 14. In one particular embodiment, although claimed subject matter is not limited in these respects, logic of data port 14 and/or power signal controller 16 to determine whether a connected device 28 is a powered device may be employed according to one or more techniques described in IEEE Std. 802.3af-2003, clause 33. Such techniques may comprise, for example, probing the connected device 28 for the detection and/or classification of powered devices. However, this is merely an example of logic that may be employed for determining whether a connected device is a powered device and claimed subject matter is not limited in these respects.

According to an embodiment, host 18 may be capable of communicating with a data transmission network through a transceiver 20. Here, for example, host 18 may comprise a media access control (MAC) device that is coupled to transceiver 20 at a media independent interface (MII). Transceiver 20 may comprise circuitry and/or logic to transmit data to and/or receive data from a physical data transmission medium.

According to an embodiment, although claimed subject matter is not limited in this respect, host 18 may selectively enable and/or disable transmission of a power signal to data ports indirectly according to a predetermined schedule. Here, processes executing on host 18 may determine a time of day, week, and month, etc. that an individual data port 14 is to receive a power signal from a power signal controller for powering a corresponding device 28. In one particular embodiment, host 18 may store information in a storage medium (not shown) indicating time intervals when one or more particular data ports are to receive a power signal. Such time intervals may be expressed as, for example, periodic time intervals (e.g., days of the week and/or times of day) and/or calendar dates and/or times. However, these are merely examples of how a computing platform may enable the scheduling of data ports to receive a power signal and claimed subject matter is not limited in these respects.

In one particular embodiment, although claimed subject matter is not limited in this respect, host 18 may enable individually scheduling individual data ports to receive a power signal on a periodic weekly schedule. Host 18 may enable this scheduling on hourly or smaller increments of time. In connection with a single data port, in a particular example, host 18 may enable scheduling the single data port to receive a power signal Monday through Friday from 8:00 am to 6:00 pm, but at no other time during the week. Host 18 may then enable the scheduling other data ports to receive a power signal on the same or different schedule. It should be understood, however, that this is merely an example of how data ports may be individually scheduled to receive a power signal on a periodic weekly schedule and claimed subject matter is not limited in this respect.

In another particular example, a predetermined schedule may determine that data port 14₁ is to transmit a power signal to device 28₁ always while data port 14₂ is to transmit a power signal to device 28₂ only on Saturdays and Sundays, and data port 14₃ is to transmit a power signal to device 28₃ every day of the week but only from the hours of 8:00 pm to 8:00 am. Computing platform 200 may then determine control transmission of a power signal to data ports 14₁, 14₂ and 14₃ according to this example schedule above. In one embodiment, although claimed subject matter is not limited in this respect, one or more of devices 28 may comprise WLAN access points which may be used by wireless computing devices to access a data network. Such access points may require a power signal from data ports 14 to operate and enable such access to wireless computing devices. According to a network security policy, for example, host 18 may inhibit transmission of a power signal to the wireless access points during certain times of the day (e.g., evening hours) to limit access to the data network through the wireless access points.

According to an embodiment, host 18 may associate two or data ports into a group of data ports. Host 18 may also determine a schedule for when data ports in a group of data ports are to receive a power signal from power signal controller 16. Here, processes executing on host 18 may determine a time of day, week, month, etc. that individual data ports in a group are to receive a power signal. Again, such time intervals may be expressed as, for example, periodic time intervals (e.g., days of the week and/or times of day) and/or calendar dates and/or times.

Host 18 may be capable of transmitting and/or receiving information through a wired or wireless communication link through transceiver 20 according to a data link protocol such as, for example, versions of IEEE Std. 802.3, IEEE Std. 802.11, Universal Serial Bus, Bluetooth, Firewire and/or the like. However, these are merely examples of a data link protocol that may be used for communicating over a data link and claimed subject matter is not limited in this respect. In a particular embodiment, host 18 may employ direct memory access (DMA) techniques to store data received from a data link in buffer locations of a storage medium (not shown) and/or transmit data from such buffer locations through a data link. However, this is merely an example of how data may be transmitted data between a data link and a storage medium, and claimed subject matter is not limited in these respects.

According to an embodiment, host 18 may host processes that are capable of communicating with a data transmission network through transceiver 20 according to a network protocol such as the Internet Protocol (IP). In particular, computing platform may host any one of several processes capable of communicating according to anyone of several IP enabled protocols such as, for example, a simple network management protocol (SNMP) and a hypertext transfer protocol (HTTP). In one particular embodiment, although claimed subject matter is not limited in this respect, processes to schedule transmission of a power signal to one or more data ports and/or groups of data ports may be accessible through a web browser. Accordingly, such a web browser may be used to set and/or modify a schedule for when one or more data ports and/or groups of data ports are to receive a power signal through a universal resource locator (URL).

In selectively enabling and/or disabling transmission of a power signal to data ports according to a particular embodiment, host 18 may compare a predetermined schedule with a state of a real-time clock to determine whether a power signal is to be transmitted to a data port and/or data ports in accordance with the predetermined schedule. Such a state of a real-time clock may comprise, for example, a time reference such as calendar date, month, week, year, day of week, time of day and/or the like. However, these are merely examples of a time reference that may comprise a state of a real-time clock and claimed subject matter is not limited in these respects. In one particular embodiment, host 18 may comprise an internal battery-backed real-time clock (not shown) that may be initialized and/or set through an SNMP and/or HTTP interface accessible through transceiver 20. Alternatively, host 18 may automatically initialize and/or synchronize its real-time clock with a client computing platform (not shown) being used by a user to remotely set a predetermined schedule as illustrated above. In yet another alternative embodiment, host 18 may initialize and/or synchronize its real-time clock by accessing a network time protocol server on a local or wide area network accessible through transceiver 20.

According to a particular embodiment, apparatus 124 may comprise “midspan” power insertion equipment in that signals transmitting data between devices 22 and 28 may be transmitted through data ports 12 and 14 without modification. Here, for example, data ports 12 and 14 may each comprise a plurality of conductive pins for transmitting data and/or a power signal. Pins of a data port 12 for transmitting data may be directly connected to corresponding pins of a data port 14 by conductors (e.g., printed circuit board traces). It should be understood, however, that such a midspan implementation comprises merely a particular embodiment and that claimed subject matter is not limited to such. In alternative embodiments, for example, a power signal may be transmitted with data over a cable in an “endpoint” solution.

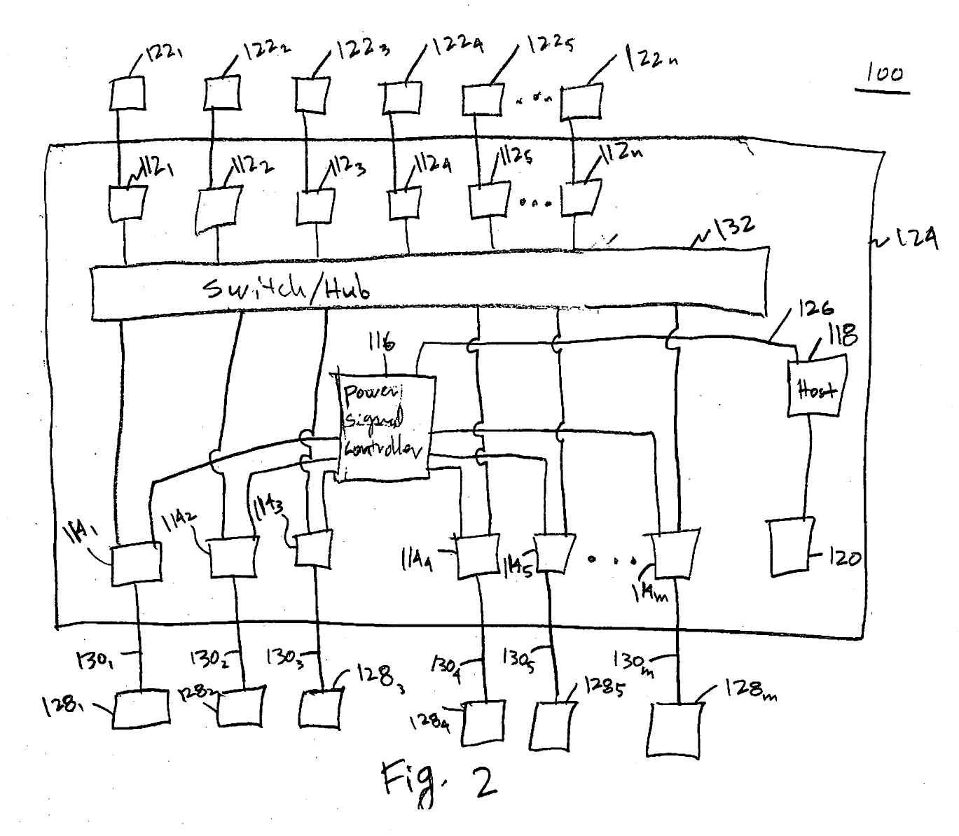

FIG. 2 is a schematic diagram of an apparatus 124 capable of applying a power signal to one or more data ports according to an alternative embodiment. As in apparatus 24 of FIG. 1, data ports 114 may be capable of transmitting a power signal to devices 128 over cables 130, in addition to transmitting data to and/or receiving from devices 128 over cables 130. Additionally, power signal controller 116 may selectively transmit a power signal through to devices 128 through ports 114 based, at least in part, on control signals received on bus 126 from host 118. However, data ports 114 do not necessarily transmit data between a corresponding device 128 and any particular data port 112. Instead, data ports 112 are connected to data ports 114 by a switch and/or hub 132 that is capable of transmitting data between any data port 112 or data port 114 and any other data port 112 or data port 114 according to an address associated with the transmitted data. In one particular embodiment, although claimed subject matter is not limited in this respect, switch and/or hub 132 may forward data between data ports in data frames and/or data packets formatted according to a predetermined communication protocol. However, this is merely an example of how a switch and/or hub may transmit data between data ports according to an address and claimed subject matter is not limited in these respects.

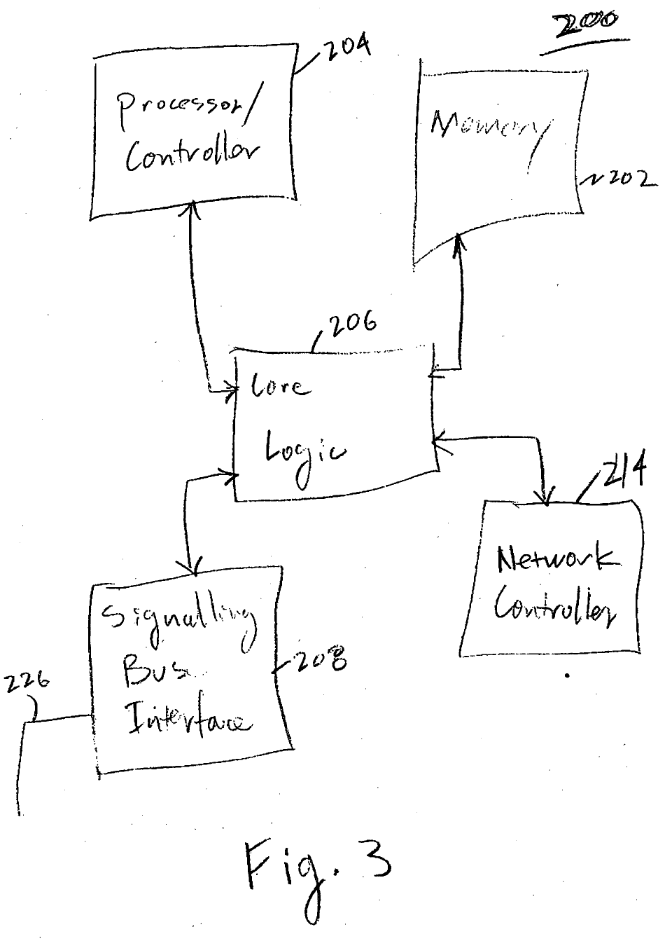

FIG. 3 is a schematic diagram of a computing platform 200 to control scheduling transmission of a power to one or more data ports according to an embodiment of host 18 and/or host 118. A processor/controller 204, memory 202, signaling bus interface 208 and network controller 214 may be communicatively coupled by core logic 206. In one particular embodiment, although claimed subject matter is not limited in this respect, the devices of computing platform 200 may be formed in a single semiconductor devices or more than one semiconductor device. In another embodiment, computing platform 200 may comprise one or more commercially available processing devices such as, for example, a Tafiatech TF-331 Enhanced Web Server Controller. According to an embodiment, core logic 206 may enable devices to communicate with one another over particular device interfaces. Core logic 206 may comprise logic and/or controllers formed on one or more semiconductor devices using techniques known to those of ordinary skill in the art.

Memory 202 may comprise one or more memory devices such as, for example, random access memory (RAM), flash memory and/or any other type of memory devices capable of storing data and/or machine readable instructions. Processor/controller 204 may execute machine-readable instructions formatted according to a particular command set to process data stored in memory 202. Actions performed by host 18 as described above may be performed and/or enabled, in whole or in part, by the execution of machine-readable instructions by processor/controller 204. In a particular example, processes executing on processor/controller 204 according to machine-readable instructions may enable and/or disable transmission of a power signal to a port based, at least in part, on a predetermined schedule. It should be understood, however, that such execution of machine-readable instructions on a processor/controller is merely an example of how logic may be implemented in host 18 to perform the above described actions, and claimed subject matter is not limited in these respects.

According to a particular embodiment, signaling bus interface 208 may transmit signals on a signaling bus 226 to a power signal controller (e.g., power signal controller 16 and/or 116) to selectively enable and/or disable transmission of a power signal to data ports (e.g., data ports 14 and/or 114). Here, processes executing on processor/controller 204 may control the transmission of a power signal to such data ports.

While there has been illustrated and described what are presently considered to be example embodiments, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

What is claimed is:

1. An apparatus comprising:
one or more data ports capable of transmitting data and a power signal to one or more devices through a cable; and
logic to control transmission of said power signal to at least one of said devices according to a predetermined schedule.

2. The apparatus of claim 2, wherein said data ports comprise substantially Ethernet compatible data ports.

3. The apparatus of claim 1, and further comprising logic to determine whether individual ones of said one or more devices comprise powered devices.

4. The apparatus of claim 1, wherein said predetermined schedule is capable of being modified in response to input data received according to an HTTP protocol.

5. The apparatus of claim 1, the apparatus comprising a plurality of said data ports and wherein said logic is capable of associating two or more of said data ports with a predetermined group of said data ports and capable of selectively scheduling transmission of said power signal to said data ports in said predetermined group according to a predetermined schedule associated with said group.

6. The apparatus of claim 1, wherein said apparatus further comprises one or more unpowered data ports connected to respective ones of said one or more data ports capable of transmitting data and a power signal.

7. The apparatus of claim 1, wherein said apparatus further comprises:
one or more unpowered data ports; and
a hub and/or switch connecting said unpowered data ports to said one or more data ports capable of transmitting data and a power signal.

8. The apparatus of claim 1, wherein said apparatus further comprises a real-time clock, and wherein said logic to control transmission of said power signal further comprises logic to compare said predetermined schedule with a state of said real-time clock.

9. The apparatus of claim 8, wherein said logic to control transmission of said power signal further comprises logic to determine whether said one or more devices are to receive said power signal based, at least in part, on said comparison of said predetermined schedule with said state of said real-time clock.

10. The apparatus of claim 8, wherein said apparatus further comprises logic to synchronize said real-time clock with a device coupled to said apparatus over a data transmission network according to a network time protocol.

11. The apparatus of claim 8, wherein said apparatus further comprises logic to synchronize said real-time clock according to information received according to an HTTP protocol.

12. The apparatus of claim 1, wherein said predetermined schedule defines a periodic weekly schedule defining one or more intervals during which at least one of said one or more devices is to receive said power signal.

13. The apparatus of claim 1, wherein said cable comprises an unshielded twisted pair cable.

14. The apparatus of claim 1, wherein said cable comprises substantially a category 5 cable.

15. An article comprising:
a storage medium comprising machine-readable instructions stored thereon to:
control transmission of a power signal through one or more data ports connected to devices according to a predetermined schedule, said data ports being capable of transmitting data and said power signal to said devices.

16. Article of claim 15, wherein said data ports comprise substantially Ethernet compatible data ports.

17. The article of claim 15, wherein said storage medium further comprises machine readable instructions stored thereon to modify said predetermined schedule in response to input data received according to an HTTP protocol.

18. The article of claim 15, wherein said storage medium further comprises machine-readable instructions stored thereon to
associate two or more of said data ports with a group of said data ports; and
selectively schedule transmission of said power signal to said data ports in said group according to a predetermined schedule associated with said group.

19. The article of claim 15, wherein said storage medium further comprises machine-readable instructions stored thereon to compare said predetermined schedule with a state of a real-time clock.

20. The article of claim 19, wherein said storage medium further comprises machine-readable instructions stored thereon to determine whether said one or more devices are to receive said power signal based, at least in part, on said comparison of said predetermined schedule with said state of said real-time clock.

21. The article of claim 19, wherein said storage medium further comprises machine-readable instructions stored thereon to synchronize said real-time clock with a device according to a network time protocol.

22. The article of claim 19, wherein said storage medium further comprises machine-readable instructions stored thereon to synchronize said real-time clock according to information received according to an HTTP protocol.

23. The article of claim 15, wherein said predetermined schedule defines a periodic weekly schedule defining one or more intervals during which at least one of said one or more devices is to receive said power signal.

24. A method comprising:
connecting one or more devices to one or more data ports; and
controlling transmission of a power signal through at least one of said one or more data ports to at least one of said one or more devices according to a predetermined schedule, said one or more data ports being capable of transmitting data and said power signal to said one or more devices.

25. The method of claim 24, wherein said connecting further comprises connecting one or more cables between said one or more devices and said one or more data ports, said one or more cables being capable of transmitting said data and said power signal simultaneously.

26. The method of claim 24, wherein said data ports comprise substantially Ethernet compatible data ports.

27. The method of claim 24, and further comprising determine whether individual ones of said one or more devices comprise powered devices.

28. The method of claim 24, and further comprising modifying said predetermined schedule in response to input data received according to an HTTP protocol.

29. The method of claim 24, wherein said one or more data ports comprises a plurality of data ports, and wherein said method further comprises:
associating two or more of said data ports with a predetermined group of said data ports; and
selectively scheduling transmission of said power signal to said data ports in said predetermined group according to a predetermined schedule associated with said group.

30. The method of claim 24, wherein said controlling transmission of said power signal further comprises comparing said predetermined schedule with a state of a real-time clock.

31. The method of claim 30, and further comprising determining whether said one or more devices are to receive said power signal based, at least in part, on said comparison of said predetermined schedule with said state of said real-time clock.

32. The method of claim 30, and further comprising synchronizing said real-time clock with a device over a data transmission network according to a network time protocol.

33. The method of claim 30, and further comprising synchronizing said real-time clock according to information received according to an HTTP protocol.

34. The method of claim 24, wherein said predetermined schedule defines a periodic weekly schedule defining one or more intervals during which at least one of said one or more devices is to receive said power signal.
